(19) United States
(12) Patent Application Publication
(10) Pub. No.: US 2025/0140871 A1
(43) Pub. Date: May 1, 2025

(54) METHOD OF MANUFACTURING BATTERY, ELECTRODE, ELECTRODE BODY, AND BATTERY

(71) Applicant: TOYOTA JIDOSHA KABUSHIKI KAISHA, Toyota-shi (JP)

(72) Inventors: Yosuke SHIMURA, Nagakute-shi (JP); Takahiko NAKANO, Nagoya-shi (JP); Hirokazu TAKEUCHI, Toyota-shi (JP); Masato NODA, Toyota-shi (JP); Atsushi SUGIHARA, Toyota-shi (JP); Jun IZUMI, Toyota-shi (JP); Yuka YOKOI, Nagoya-shi (JP)

(21) Appl. No.: 18/929,647

(22) Filed: Oct. 29, 2024

(30) Foreign Application Priority Data
Oct. 31, 2023 (JP) 2023-186921

(51) Int. Cl. H01M 4/70; H01M 4/04

(52) U.S. Cl. CPC H01M 4/70; H01M 4/0404

(57) ABSTRACT

A method of manufacturing a battery that includes an electrode containing a current collector and an electrode layer arranged on the current collector, the method including: a first step of forming an electrode layer on a current collector; and a second step of forming a groove in a surface of the electrode layer, wherein the groove is formed by removing a part of the electrode layer by laser irradiation.

### CROSS-REFERENCE TO RELATED APPLICATION

This application is based on and claims priority under 35 USC 119 from Japanese Patent Application No. 2023-186921, filed on Oct. 31, 2023, the disclosure of which is incorporated by reference herein.

### BACKGROUND

### Technical Field

The present disclosure relates to a method of manufacturing a battery, an electrode, an electrode body, and a battery.

### Related Art

In a process for manufacturing a battery using an electrolytic solution obtained by dissolving an electrolyte in an organic solvent, a liquid injection operation is performed in which the electrolytic solution is supplied to an interior of an exterior body that accommodates an electrode body, and the electrolytic solution is caused to permeate into the electrode body.

In some cases, a process is performed in which an electrode of the battery is pressed at a high pressure in order to increase an energy density. When a packing density of an electrode active material within the electrode is increased by pressing the electrode, a permeability of the electrolytic solution decreases. The decrease in the permeability of the electrolytic solution causes a decrease in the efficiency of the liquid injection operation, and furthermore, is a cause of reducing production efficiency of the battery.

As a method of reducing the time required for the liquid injection operation of an electrolytic solution into an electrode body, for example, Japanese Patent Application Laid-Open (JP-A) No. 2001-068085 discloses a method of providing a slit in a separator that is disposed between a positive electrode and a negative electrode.

In a case of producing an electrode body by disposing a separator having a slit between the electrodes, as in the method described in JP-A No. 2001-068085, there is a possibility that the density of the electrodes in the electrode body after pressing is not sufficiently equalized.

### SUMMARY

In view of the foregoing, an object of one embodiment of the present disclosure is to provide a novel method of manufacturing a battery, an electrode, an electrode body, and a battery, which are excellent in permeability of an electrolytic solution and maintain a favorable energy density.

The means for solving the above-described problem includes the following embodiments.

<1> A method of manufacturing a battery that includes an electrode containing a current collector and an electrode layer arranged on the current collector, the method including:
a first step of forming an electrode layer on a current collector; and
a second step of forming a groove in a surface of the electrode layer,
wherein the groove is formed by removing a part of the electrode layer by laser irradiation.

<2> The method of manufacturing a battery according to <1>, wherein a density of a part corresponding to an underneath of the groove of the electrode layer is equal to a density of a part of the electrode layer which does not have the groove.

<3> An electrode, including:
a current collector; and
an electrode layer that is disposed on the current collector,
wherein a surface of the electrode layer includes a groove, and
wherein a density of a part corresponding to an underneath of the groove of the electrode layer is equal to a density of a part of the electrode layer which does not have the groove.

<4> An electrode body, including the electrode according to <3>.

<5> A battery, including the electrode according to <3>.

### BRIEF DESCRIPTION OF THE DRAWINGS

Embodiments of the present disclosure will be described in detail based on the following figures, wherein:

FIG. 1 is a diagram schematically illustrating an example of a configuration of an electrode body;

FIG. 2 is a diagram schematically illustrating an example of application of a battery module to an electric vehicle;

FIG. 3 is a diagram schematically illustrating an example of a configuration of a battery module;

FIG. 4 is a diagram schematically illustrating an example of a configuration of a battery module; and

FIG. 5 is a diagram schematically illustrating an example of a configuration of a battery cell included in a battery module.

### DETAILED DESCRIPTION

In the present disclosure, a numerical value range expressed by using “(from) . . . to . . . ”, means a range in which the numerical values before and after the word “to” are included as the minimum value and the maximum value, respectively.

In the numerical value ranges that are expressed in a stepwise manner in the present disclosure, the upper limit value or the lower limit value described in a given numerical value range may be replaced with the upper limit value or the lower limit value of another numerical value range that is expressed in a stepwise manner. In the numerical value ranges described in the present disclosure, the upper limit value or the lower limit value described in a given numerical range may be replaced with a value shown in the examples.

In the present disclosure, the term “step” includes not only an independent step, but also a step that cannot be clearly distinguished from another step as long as the intended purpose of the step is achieved.

In the case in which embodiments are described in the present disclosure with reference to the drawings, the configuration of an embodiment is not limited to the configuration illustrated in the drawings. Further, the sizes of the members in the drawings are conceptual, and the relative relationship between the sizes of the members is not limited thereto.

### Method of Manufacturing a Battery

The method of manufacturing a battery of the present disclosure is a method of manufacturing a battery that includes an electrode containing a current collector and an electrode layer arranged on the current collector, the method including: a first step of forming an electrode layer on a current collector; and a second step of forming a groove in a surface of the electrode layer, wherein the groove is formed by removing a part of the electrode layer by laser irradiation.

In the method of the present disclosure, formation of the groove in the surface of the electrode layer is performed by removing a part of the electrode layer by laser irradiation.

The groove that is formed in the electrode layer serves, for example, as a migration path for an electrolytic solution in a planar direction of the electrode layer, and promotes permeation of the electrolytic solution into the electrode.

As a method of forming a groove in an electrode layer, there is exemplified a method of forming a pattern composed of a region in which an electrode layer is formed on a current collector and a region in which an electrode layer is not formed, and using the region in which an electrode layer is not formed as a groove.

However, in the above-described method, since a portion corresponding to the groove does not have an electrode layer that contains an active material, the energy density of the electrode may decrease.

In the method of the present disclosure, in which a groove is formed by laser irradiation, a depth of the groove can be readily controlled so as to be smaller than a thickness of the electrode layer, and an active material can be present in a region corresponding to the groove of the electrode layer. As a result, a reduction in the energy density due to formation of the groove can be suppressed.

A further exemplary method of forming a groove in an electrode layer is a method of using, as the groove, a recess formed by pressurizing a region corresponding to the groove of the electrode layer.

However, in the above-described method, the density of the region in which the groove of the electrode layer is formed may become higher than the design value, and the permeability of the electrolytic solution may be lowered.

In the method of the present disclosure, in which the groove is formed by laser irradiation, the groove is formed by removing a part of the electrode layer. As a result, the density of the region corresponding to the groove of the electrode layer is kept from being too high, and favorable permeability of the electrolytic solution is maintained. Further, it is advantageous, in terms of achieving favorable battery performances, that the density of the electrode layer is uniform regardless of the presence or absence of a groove.

A battery that is manufactured by the method of the present disclosure includes an electrode containing a current collector and an electrode layer arranged on the current collector. At least a part of the electrode has a groove formed in the electrode layer.

It is possible that all of the electrodes included in the battery have a groove formed in the electrode layer, or it is possible that some of the electrodes included in the battery have a groove formed in the electrode layer.

For example, in a case in which either one of a negative electrode or a positive electrode included in the battery has a groove formed in the electrode layer, the other of the negative electrode or the positive electrode included in the battery may or may not have a groove formed in the electrode layer.

In general, a negative electrode has more voids between active material particles than a positive electrode, and has excellent permeability of an electrolytic solution. For this reason, the negative electrode may have a groove formed in the electrode layer.

### First Step

In the first step, an electrode layer is formed on the current collector.

The method of forming the electrode layer on the current collector is not particularly limited, and may be selected from known methods. For example, a composition that includes a component contained in an electrode layer may be coated on a current collector to form an electrode layer. Examples of the component contained in the electrode layer include an electrode active material, a conductive material, and a binder.

Specific examples of a positive electrode active material in a case in which the battery is a lithium-ion secondary battery include composite oxides formed of lithium and a transition metal, and optionally other metals (hereinafter, also referred to as lithium transition metal composite oxides). Examples of transition metals and other metals include Ni, Co, Mn, Al, B, Mg, Ti, V, Cr, Fe, Cu, Zn, Ga, Sr, Zr, Nb, In, Sn, Ta, W, and the like.

Examples of the lithium transition metal composite oxides include layered lithium transition metal composite oxides, spinel-type lithium transition metal composite oxides, and olivine-type lithium transition metal composite oxides.

Examples of the layered lithium transition metal composite oxides include those containing at least one selected from Ni, Co or Mn as the transition metal. Specific examples thereof include compounds represented by the structural formula of LiNiₐCO_{b}Mn_{c}O₂ (a, b, and c each being a number greater than or equal to 0 and less than or equal to 1, and a+b+c=1), and compounds in which one or more elements selected from Al, Mg, La, Ti, Zn, B, W, Fe, Cr, V, Ru, Cu, Cd, Ag, Y, Sc, Ga, In, As, Sb, Pt, Au, Si, or the like are added to the aforementioned compounds.

Specific examples of the spinel-type lithium transition metal complex oxides include LiMn₂O₄.

Specific examples of the olivine-type lithium transition metal complex oxides include LiMPO₄ (M: Fe, Co, Ni or Mn).

The positive electrode active material contained in the electrode layer may be a single type or two or more types thereof.

Specific examples of a negative electrode active material in a case in which the battery is a lithium-ion secondary battery include carbon materials such as graphite, hard carbon, soft carbon, and activated carbon, silicon, metallic lithium, lithium alloys, and lithium titanate (LTO).

The negative electrode active material contained in the electrode layer may be a single type or two or more types thereof.

Specific examples of the conductive material include carbon materials such as carbon black (acetylene black, thermal black, and furnace black), carbon nanotubes, and graphite.

The conductive material contained in the electrode may be a single type or two or more types thereof.

Specific examples of the binder include polyvinylidene fluoride (PVdF), polyethylene, polypropylene, polyethylene terephthalate, cellulose, nitrocellulose, carboxymethylcellulose, polyethylene oxide, polyepichlorohydrin, polyacrylonitrile, styrene-butadiene rubber (SBR), acrylonitrile-butadiene rubber (NBR), polyacrylate, polymethacrylate, and polytetrafluoroethylene (PTFE).

The binder contained in the electrode layer may be a single type or two or more types thereof.

Examples of the material that configures the current collector of the positive electrode include aluminum, aluminum alloys, nickel, titanium, and stainless steel. Examples of the shape of the current collector include a foil and a mesh.

Examples of the material that configures the current collector of the negative electrode include copper, copper alloys, nickel, titanium, and stainless steel. Examples of the shape of the current collector include a foil and a mesh.

### Second Step

In the second step, a groove is formed in the surface of the electrode layer that has been formed in the first step. The formation of the groove is performed by removing a part of the electrode layer by laser irradiation.

The type of the laser used for forming the groove is not particularly limited, and a known laser can be used.

Specific examples of the laser include solid-state lasers such as a YAG laser, a fiber laser, and a semiconductor laser, and gas lasers such as a carbon dioxide laser, an excimer laser, and an He—Ne laser.

The electrolytic solution mainly permeates into the electrode layer from the end surface (cut surface) of the electrode layer. Therefore, from the viewpoint of promoting permeation of the electrolytic solution, the end portion of the groove that is formed in the electrode layer is preferably positioned at the end surface of the electrode layer.

From the viewpoint of further promoting permeation of the electrolytic solution, a direction of the groove that is formed in the electrode layer is preferably a direction along a flow direction of the electrolytic solution when the electrolytic solution permeates into the electrode.

The depth of the groove that is formed in the electrode layer is not particularly limited, and may be selected in accordance with the shape of the battery, the thickness of the electrode layer, and the like.

The depth of the groove that is formed in the electrode layer may be selected from, for example, a depth which is within a range of from 10% to 90% of the thickness of the electrode layer.

The thickness of the electrode layer is not particularly limited, and may be selected from conventional thicknesses of electrode layers. For example, the thickness of the electrode layer may be selected from the range of from 10 μm to 200 μm.

The number of grooves formed in the electrode layer may be one or plural.

The groove formed in the electrode layer may be provided in a stripe shape, a lattice shape, or a dendritic shape (i.e., a structure configured by a trunk part and a branch part).

From the viewpoint of maintaining favorable permeability of the electrolytic solution and achieving favorable battery performances, it is preferable that a density of a part corresponding to an underneath of the groove of the electrode layer is equal to a density of a part of the electrode layer which does not have the groove.

The electrode in which a groove is formed in the surface of the electrode layer may constitute an electrode body.

In the present disclosure, an electrode body refers to a structure including a laminated body configured by a positive electrode, a negative electrode, and a separator that is disposed between the positive electrode and the negative electrode.

Examples of the form of an electrode body including a laminated body configured by a positive electrode, a negative electrode, and a separator that is disposed between the positive electrode and the negative electrode include a state in which plural laminated bodies that have been cut to predetermined dimensions are overlapped, and a state in which an elongated laminated body is wound.

Examples of the separator included in the electrode body include nonwoven fabrics, cloths, microporous films and the like, containing a polyolefin such as polyethylene, polypropylene or the like, as a main component.

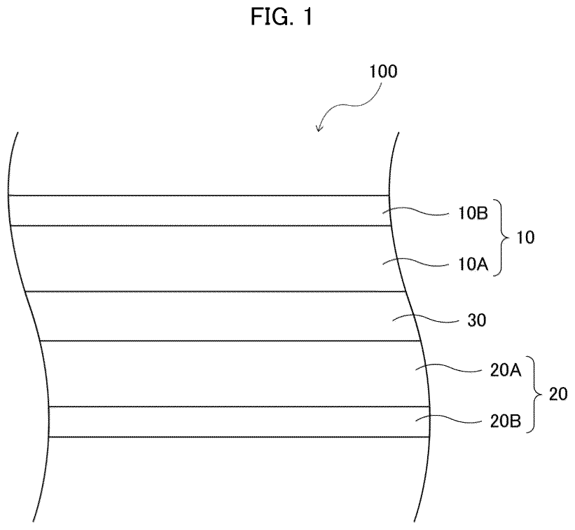

FIG. 1 schematically illustrates an example of a configuration of the laminated body contained in the electrode body.

A laminated body 100 illustrated in FIG. 1 is configured by a positive electrode 10, a negative electrode 20, and a separator 30 that is disposed between the positive electrode 10 and the negative electrode 20. The positive electrode 10 is configured by a positive electrode layer 10A and a positive electrode current collector 10B. The negative electrode 20 is configured by a negative electrode layer 20A and a negative electrode current collector 20B.

The electrode body is accommodated in an exterior body of the battery.

The type of the exterior body in which the electrode body is accommodated is not particularly limited, and may be selected in accordance with the type of the battery.

In certain embodiments, a sheet-shaped exterior body may be used.

Examples of the sheet-shaped exterior body include those containing a metal. Specific examples include laminated bodies (so-called laminate films) having a metal layer containing a metal such as aluminum or the like, and a heat seal layer containing a resin that is melted by heating. That is to say, the battery manufactured by the method of the present disclosure may be a battery (so-called laminate battery) in which a laminate film is used as the exterior body.

The exterior body may be a single member, or may be composed of two or more members. For example, in a case in which the exterior body is a sheet-shaped object, the exterior body may be composed of one sheet-shaped object, or may be composed of two sheets-shaped objects.

If necessary, a recess for accommodating the electrode body may be formed at the sheet-shaped exterior body by embossing.

Examples of a method for accommodating the electrode body in the exterior body using a sheet-shaped exterior body include, for example, the following Method 1 and Method 2.
Method 1: a method of, in a state in which the electrode body is disposed between one exterior body that has been folded in half or between two exterior bodies that have been superposed, joining the exterior body (or bodies) at a periphery of the electrode body
Method 2: a method of inserting the electrode body into a bag that has been prepared by joining a periphery of one exterior body that has been folded in half or two exterior bodies that have been superposed

A battery can be obtained by causing an electrolytic solution to permeate into an electrode body that is accommodated in an exterior body.

As the electrolytic solution, those obtained by dissolving an electrolyte such as LiPF₆ or LiFSi in a solvent may be used without any particular limitation.

Specific examples of the solvent include cyclic or linear carbonates such as ethylene carbonate (EC), dimethyl carbonate (DMC), diethyl carbonate (DEC), and ethyl methyl carbonate (EMC). The solvent may be a mixture of two or more solvents, and may be a mixture containing a cyclic carbonate and a linear carbonate.

The solvent may contain an additive such as vinylene carbonate (VC).

### Electrode

The electrode of the present disclosure includes a current collector and an electrode layer that is disposed on the current collector, wherein the electrode layer has a groove in a surface of the electrode layer, and a density of a part corresponding to an underneath of the groove of the electrode layer is equal to a density of a part of the electrode layer which does not have the groove.

The electrode of the present disclosure has a groove in the surface of the electrode layer. This groove serves, for example, as a migration path for the electrolytic solution in the planar direction of the electrode layer and promotes permeation of the electrolytic solution into the electrode.

In the electrode of the present disclosure, the density of the part corresponding to an underneath of the groove of the electrode layer is equal to the density of the part of the electrode layer which does not have the groove. As a result, the density of the portion corresponding to the groove of the electrode layer is kept from being too high, and the permeability of the electrolytic solution is maintained satisfactorily. Further, by making the density of the electrode layer uniform, favorable battery performances can be achieved. Furthermore, since the active material is also present at a portion of the electrode layer where the groove is formed, the energy density of the electrode due to the formation of the groove is less likely to decrease.

In the electrode of the present disclosure, it is possible to generate a state in which the density of the part corresponding to an underneath of the groove of the electrode layer is equal to the density of the part of the electrode layer which does not have the groove, for example, by a method of removing a part of the electrode layer in the region in which the groove is to be formed.

Although a method of removing a part of the electrode layer in the region in which the groove is to be formed is not particularly limited, laser irradiation is preferable from the viewpoint of accurately forming a groove of a desired dimension. Whether or not the formation of the groove has been performed by laser irradiation can be determined based on a state of the surface of the groove, or other traces.

The details and preferred embodiments of the electrode of the present disclosure are the same as the details and preferred embodiments of the electrode in the method of manufacturing a battery as described above.

### Electrode Body

The electrode body of the present disclosure includes the electrode of the present disclosure as described above.

The details and preferred embodiments of the electrode body of the present disclosure are the same as the details and preferred embodiments of the electrode body in the method of manufacturing a battery as described above.

### Battery

The battery of the present disclosure includes the electrode of the present disclosure as described above. The battery of the present disclosure may be a battery manufactured by the method of manufacturing a battery of the present disclosure as described above.

The type of battery is not particularly limited.

Specific examples of the battery include secondary batteries such as lithium-ion secondary batteries, lead storage batteries, nickel-hydrogen storage batteries, nickel-cadmium storage batteries, nickel-iron storage batteries, nickel-zinc storage batteries, silver oxide-zinc storage batteries, and cobalt-titanium-lithium secondary batteries.

From the viewpoint of energy density, versatility, and the like, the battery may be a lithium-ion secondary battery.

The battery of the present disclosure may be installed at an electric vehicle. Explanation follows of an example in which the battery of the present disclosure is applied to an electric vehicle, with reference to the drawings. In the following explanation, “battery cell 20” corresponds to the battery of the present disclosure.

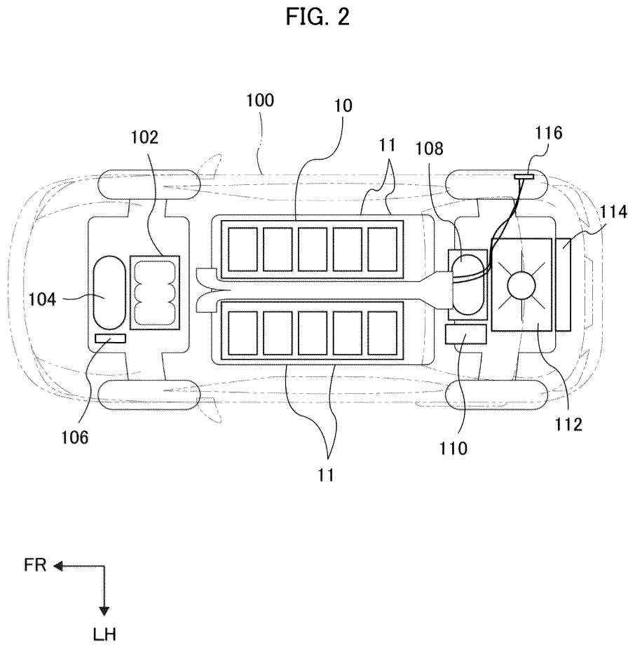

FIG. 2 is a schematic plan view illustrating a main part of a vehicle 100 to which a battery pack 10 according to an embodiment has been applied. As illustrated in FIG. 2, the vehicle 100 is an electric vehicle (battery electric vehicle (BEV)) at which the battery pack 10 is installed under a floor. It should be noted that in each of the drawings, the arrow UP, the arrow FR, and the arrow LH respectively indicate an upper side in a vehicle up-down direction, a front side in a vehicle front-rear direction, and a left side in a vehicle width direction. In cases in which explanation is given using front-rear, left-right, and up-down directions, unless otherwise specified, these refer to the front and rear in the vehicle front-rear direction, the left and right in the vehicle width direction, and up and down in a vehicle up-down direction.

As an example, in the vehicle 100 of the present embodiment, a DC/DC converter 102, an electric compressor 104, and a positive temperature coefficient (PTC) heater 106 are arranged further toward a vehicle front side than the battery pack 10. Further, a motor 108, a gear box 110, an inverter 112, and a charger 114 are arranged further toward a vehicle rear side than the battery pack 10.

A DC current that has been output from the battery pack 10 is adjusted in voltage by the DC/DC converter 102, and then is supplied to the electric compressor 104, the PTC heater 106, the inverter 112, and the like. Further, by electric power being supplied to the motor 108 via the inverter 112, the rear wheels rotate to drive the vehicle 100.

A charging port 116 is provided at a right side portion of a rear portion of the vehicle 100, and by connecting a charging plug of an external charging facility, which is not illustrated in the drawings, from the charging port 116, electric power can be stored in the battery pack 10 via the in-vehicle charger 114.

An arrangement, structure and the like of the respective components configuring the vehicle 100 are not limited to the above-described configuration. For example, the present disclosure may be applied to vehicles installed with an engine such as hybrid vehicles (HV) and plug-in hybrid electric vehicles (PHEV). Further, in the present embodiment, although the vehicle is configured as a rear-wheel-drive vehicle in which the motor 108 is installed at a rear portion of the vehicle, there is no limitation thereto, and the vehicle may be configured as a front-wheel-drive vehicle in which the motor 108 is installed at a front portion of the vehicle, and a pair of motors 108 may also be installed at the front and rear of the vehicle. Furthermore, the vehicle may also be provided with in-wheel motors at the respective wheels.

The battery pack 10 includes plural battery modules 11. In the present embodiment, as an example, ten battery modules 11 are provided. Specifically, five battery modules 11 are arranged in the vehicle front-rear direction at the right side of the vehicle 100, and five battery modules 11 are arranged in the vehicle front-rear direction at the left side of the vehicle 100. Further, each of the battery modules 11 is electrically connected to each other.

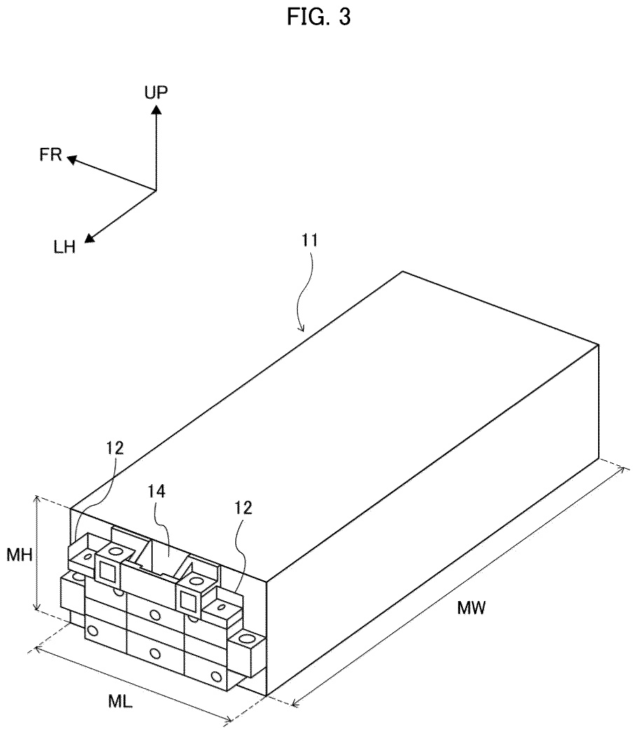

FIG. 3 is a schematic perspective view of the battery module 11. As illustrated in FIG. 3, the battery module 11 is formed in a substantially rectangular parallelepiped shape having a longitudinal direction along the vehicle width direction. Further, an outer shell of the battery module 11 is formed of an aluminum alloy. For example, the outer shell of the battery module 11 is formed by joining aluminum die-casting to both end portions of an extruded material of an aluminum alloy by laser welding or the like.

A pair of voltage terminals 12 and a connector 14 are provided at both vehicle width direction end portions of the battery module 11. A flexible printed circuit board 21, which is described below, is connected to the connector 14. Furthermore, bus bars, which are not illustrated in the drawings, are welded to both vehicle width direction end portions of the battery module 11.

A length MW of the battery module 11 in the vehicle width direction is, for example, from 350 mm to 600 mm, a length ML thereof in the vehicle front-rear direction is, for example, from 150 mm to 250 mm, and a height MH thereof in the vehicle up-down direction is, for example, from 80 mm to 110 mm.

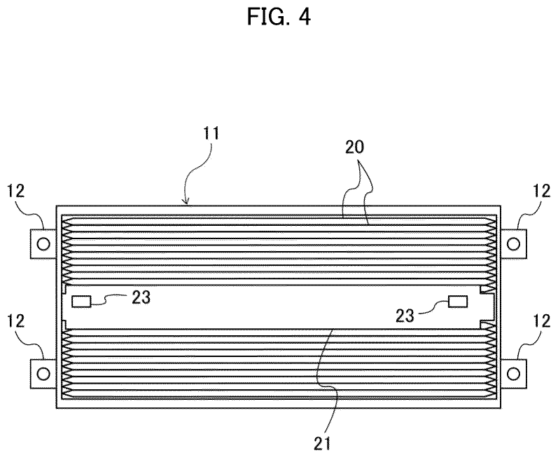

FIG. 4 is a plan view of the battery module 11 in a state in which an upper lid there of has been removed. As illustrated in FIG. 4, plural battery cells 20 are accommodated at an interior of the battery module 11 in an arranged state. In the present embodiment, as an example, twenty-four battery cells 20 are arranged in the vehicle front-rear direction and are adhered to each other.

A flexible printed circuit (FPC) board 21 is arranged on the battery cells 20. The flexible printed circuit board 21 is formed in a band shape with a longitudinal direction thereof along the vehicle width direction, and thermistors 23 are respectively provided at both end portions of the flexible printed circuit board 21. The thermistors 23 are not adhered to the battery cells 20 and are configured so to be pressed toward the battery cells 20 side by the upper lid of the battery module 11.

Further, one or more cushioning materials, which are not illustrated in the drawings, are accommodated at the interior of the battery module 11. For example, the cushioning material is a thin plate-shaped member that is elastically deformable, and is arranged between adjacent battery cells 20 with a thickness direction thereof along an arrangement direction of the battery cells 20. In the present embodiment, as an example, cushioning materials are respectively arranged at both longitudinal direction end portions of battery module 11 and at a longitudinal direction central portion of the battery module 11.

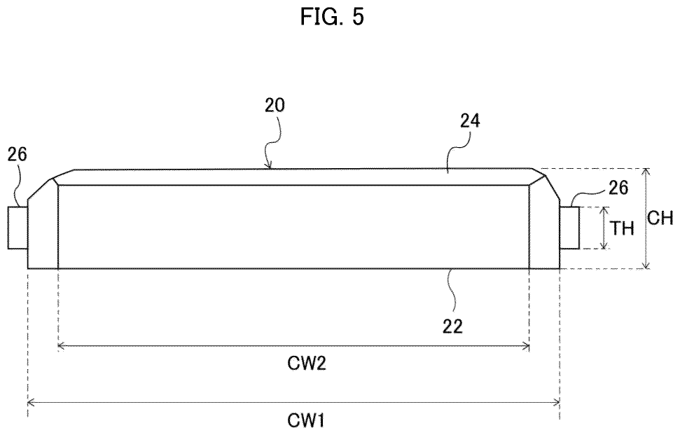

FIG. 5 is a schematic diagram in which a battery cell 20 that is accommodated in the battery module 11 is viewed from a thickness direction thereof. As illustrated in FIG. 5, the battery cell 20 is formed in a substantially rectangular plate shape, and an electrode body, which is not illustrated in the drawings, is accommodated at an interior thereof. The electrode body is configured by laminating a positive electrode, a negative electrode, and a separator, and is sealed by a laminate film 22.

In the present embodiment, as an example, the embossed sheet-shaped laminate film 22 is folded and bonded to thereby form a housing portion of the electrode body. It should be noted that although both a single-cup embossing structure in which embossing is at one location and a double-cup embossing structure in which embossing is at two locations can be adopted, in the present embodiment, the structure is a single-cup embossing structure having a draw depth of from about 8 mm to about 10 mm.

Upper ends of both longitudinal direction end portions of the battery cell 20 are folded over, and corners thereof form an outer shape. Furthermore, an upper end portion of the battery cell 20 is folded over, and a fixing tape 24 is wound around the upper end portion of the battery cell 20 along the longitudinal direction.

Terminals (tabs) 26 are respectively provided at both ends in the longitudinal direction of the battery cell 20. In the present embodiment, as an example, the terminals 26 are provided at positions that are offset downward from the center of the battery cell 20 in the up-down direction. The terminals 26 are connected to the bus bars, which are not illustrated in the drawings, by laser welding or the like.

For example, the battery cell 20 has a length CW1 in the vehicle width direction of from 530 mm to 600 mm, from 600 mm to 700 mm, from 700 mm to 800 mm, from 800 mm to 900 mm, or greater than or equal to 1000 mm; a length CW2 of the region in which the electrode body is housed of from 500 mm to 520 mm, from 600 mm to 700 mm, from 700 mm to 800 mm, from 800 to 900 mm, or greater than or equal to 1000 mm; a height CH of from 80 mm to 110 mm or from 110 mm to 140 mm; a thickness of from 5.0 mm to 7.0 mm, from 7.0 mm to 9.0 mm, or from 9.0 mm to 11.0 mm; and a height TH of the terminal 26 of from 40 mm to 50 mm, from 50 mm to 60 mm, or from 60 mm to 70 mm.

All publications, patent applications, and technical standards mentioned in the present specification are incorporated herein by reference to the same extent as if each individual publication, patent application, or technical standard was specifically and individually indicated to be incorporated by reference.

What is claimed is:

1. A method of manufacturing a battery comprising an electrode that includes a current collector and an electrode layer disposed on the current collector, the method comprising:
a first step of forming an electrode layer on a current collector; and
a second step of forming a groove in a surface of the electrode layer,
wherein the groove is formed by removing a part of the electrode layer by laser irradiation.

2. The method of manufacturing a battery according to claim 1, wherein a density of a part corresponding to an underneath of the groove of the electrode layer is equal to a density of a part of the electrode layer which does not have the groove.

3. An electrode, comprising:
a current collector; and
an electrode layer that is disposed on the current collector,
wherein a surface of the electrode layer includes a groove, and
wherein a density of a part corresponding to an underneath of the groove of the electrode layer is equal to a density of a part of the electrode layer which does not have the groove.

4. An electrode body, comprising the electrode according to claim 3.

5. A battery, comprising the electrode according to claim 3.
